(19) United States
(12) Patent Application Publication
(10) Pub. No.: US 2022/0375234 A1
(43) Pub. Date: Nov. 24, 2022

(54) LANE LINE RECOGNITION METHOD, DEVICE AND STORAGE MEDIUM

(71) Applicants: CHENGDU KUANGSHI JINZHI TECHNOLOGY CO., LTD., Chengdu, Sichuan (CN); BEIJING KUANGSHI TECHNOLOGY CO., LTD., Beijing (CN)

(72) Inventors: Yi ZHANG, Chengdu, Sichuan (CN); Lanpeng JIA, Chengdu, Sichuan (CN); Shuaicheng LIU, Chengdu, Sichuan (CN)

(21) Appl. No.: 17/767,367

(22) PCT Filed: Sep. 15, 2020
(86) PCT No.: PCT/CN2020/115390

§ 371 Date: Apr. 7, 2022

(30) Foreign Application Priority Data
Nov. 21, 2019 (CN) 201911147428.8

(51) Int. Cl. G06V 20/56; G06T 7/70; G06T 7/13; G06V 10/764; G06T 3/40; G06T 7/20; G06T 7/11; G06V 10/22

(52) U.S. Cl. CPC G06V 20/588; G06T 7/70; G06T 7/13; G06V 10/764; G06T 3/40; G06T 7/20; G06T 7/11; G06V 10/22; G06T 2207/30256; G06T 2207/20021

(57) ABSTRACT

A lane line recognition method, a device and a storage medium are provided. The position information of lane lines is determined by first detecting a current frame image collected by a vehicle and determining a plurality of detection frames where the lane lines in the current frame image are located, determining a connection area according to the position information of the plurality of detection frames where the connection area includes the lane lines, and then performing edge detection on the connection area and determining the position information of the lane lines in the connection area. That is to say, the position information of the lane lines is obtained by first dividing the current frame image into a plurality of detection frames, then connecting the detection frames to obtain the connection area including the lane lines, and then performing edge detection on the connection area.

The present application claims the priority of the Chinese patent application with the application No. 201911147428.8 and the title “lane line recognition method, apparatus, device and storage medium” which was filed to the China Patent Office on Nov. 21, 2019, and the entire content of this Chinese patent application is incorporated herein by reference.

### TECHNICAL FIELD

The present disclosure relates to the technical field of image recognition, in particular to a lane line recognition method, an apparatus, a device and a storage medium.

### BACKGROUND

With the vigorous development of artificial intelligence technology, automatic driving has become a possible driving method. Automatic driving usually obtains environment images around a vehicle through a camera, and uses artificial intelligence technology to acquire road information from the environment images, so as to control the vehicle to drive according to the road information.

The process of using artificial intelligence technology to acquire road information from environment images usually comprises determining lane lines in the vehicle driving section from environment images. Lane lines, as common traffic signs, comprise many different types of lane lines. For example, in terms of color, lane lines comprise white lines and yellow lines. In terms of purpose, lane lines are divided into dashed lines, solid lines, double solid lines and double dashed lines. When a terminal determines the lane lines from the environment images, it usually determines the lane lines through pixel grayscale of different areas in the environment images. For example, the area where the pixel grayscale in the environment images is significantly higher than that of surrounding areas is determined as a solid line area.

However, the pixel grayscale of the environment images may be changed by effects of white balance algorithm of an image sensor, different light intensity and ground reflection, resulting in inaccurate lane lines determined according to the pixel grayscale of the environment images.

### SUMMARY

Based on this, it is necessary to provide a lane line recognition method, an apparatus, a device and a storage medium for the problem of inaccurate lane lines determined by traditional methods.

In the first aspect, a lane line recognition method comprises:

detecting a current frame image collected by a vehicle and determine a plurality of detection frames where the lane lines in the current frame image are located;

determining a connection area according to position information of a plurality of detection frames, and the connection area comprising lane lines; and

performing edge detection on the connection area and determining position information of the lane lines in the connection area.

In one embodiment, detecting the current frame image collected by the vehicle and determining a plurality of detection frames where the lane lines in the current frame image are located comprises:

inputting the current frame image into a lane line classification model to obtain the plurality of detection frames where the lane lines in the current frame image are located, where the lane line classification model comprises at least two classifiers that is cascaded.

In one embodiment, inputting the current frame image into the lane line classification model to obtain the plurality of detection frames where the lane lines in the current frame image are located comprises:

performing a scaling operation on the current frame image according to an area size which is recognizable by the lane line classification model so as to obtain a scaled current frame image; and

obtaining the plurality of detection frames where the lane lines in the current frame image are located according to the scaled current frame image and the lane line classification model.

In one embodiment, obtaining the plurality of detection frames where the lane lines in the current frame image are located according to the scaled current frame image and the lane line classification model comprises:

performing a sliding window operation on the scaled current frame image according to a preset sliding window size so as to obtain a plurality of images to be recognized; and

inputting the plurality of images to be recognized into the lane line classification model successively to obtain the plurality of detection frames where the lane lines are located.

In one embodiment, determining the connection area according to the position information of the plurality of detection frames comprises:

merging the plurality of detection frames according to the position information of the plurality of detection frames and determining a merging area where the plurality of detection frames are located; and

determining the connection area corresponding to the plurality of detection frames according to the merging area.

In one embodiment, performing the edge detection on the connection area and determining the position information of the lane lines in the connection area comprises:

performing the edge detection on the connection area to obtain a target edge area; and

taking position information of the target edge area as the position information of the lane lines in the case where the target edge area meets a preset condition.

In one embodiment, the above preset condition comprises at least one selecting from a group consisting of: the target edge area comprises a left edge and a right edge, a distal width of the target edge area is less than a proximal width of the target edge area, and the distal width of the target edge area is greater than a product of the proximal width and a width coefficient.

In one embodiment, the method further comprises:

performing target tracking on a next frame image of the current frame image according to the position information of the lane lines in the current frame image and obtaining position information of the lane lines in the next frame image.

In one embodiment, according to a recognition result, performing the target tracking on the next frame image of the current frame image according to the position information of the lane lines in the current frame image and obtaining position information of the lane lines in the next frame image comprises:

dividing the next frame image into a plurality of area images;

selecting an area image in the next frame image corresponding to the position information of the lane lines in the current frame image as a target area image; and

performing the target tracking on the target area image to acquire the position information of the lane lines in the next frame image.

In one embodiment, the method further comprises:

determining an intersection of the lane lines according to the position information of lane lines in the current frame image;

determining a lane line estimation area according to the intersection of lane lines and the position information of the lane lines in the current frame image; and

selecting an area image corresponding to the lane line estimation area in the next frame image of the current frame image as the next frame image.

In one embodiment, the method further comprises:

determining a driving state of the vehicle according to the position information of the lane lines, where the driving state of the vehicle comprises line-covering driving; and

outputting warning information in the case where the driving state of the vehicle meets a warning condition that is preset.

In one embodiment, the above warning condition comprises that the vehicle is driving on a solid line, or a duration of the vehicle covering a dotted line exceeds a preset duration threshold.

In the second aspect, a lane line recognition apparatus comprises:

a detection module, configured to detect a current frame image collected by a vehicle and determine a plurality of detection frames where lane lines in the current frame image are located;

a first determination module, configured to determine a connection area according to position information of the plurality of detection frames, where the connection area comprises the lane lines; and

a second determination module, configured to perform edge detection on the connection area and determine position information of the lane lines in the connection area.

In the third aspect, a computer device comprises a memory and a processor, the memory stores computer programs, and the processor implements steps of the above lane line recognition method when executing the computer programs.

In the fourth aspect, a computer-readable storage medium, which stores computer programs thereon, and the computer programs implement steps of the above-mentioned lane line recognition method when executed by a processor.

In the above lane line recognition method, the apparatus, the device and the storage medium, the position information of the lane lines is determined by first detecting the current frame image collected by the vehicle, determining a plurality of detection frames where the lane lines in the current frame image are located, determining the connection area which comprises the lane lines according to the position information of the plurality of detection frames, and then performing edge detection on the connection area and determining the position information of the lane lines in the connection area. That is to say, the position information of the lane lines is obtained by first dividing the current frame image into a plurality of detection frames, then connecting the detection frames to obtain the connection area comprising the lane lines, and then performing edge detection on the connection area, so as to avoid the problem of inaccurate position information of the determined lane lines when the pixel grayscale of the environment image changes drastically, thereby improving the accuracy of the position information of the determined lane lines.

The above description is only an overview of the technical schemes of the present disclosure. In order to understand the technical schemes of the present disclosure more clearly, it can be implemented according to the contents of the description, and in order to make the above and other purposes, features and advantages of the present disclosure more obvious and easy to understand, the specific embodiments of the present disclosure are described below.

### BRIEF DESCRIPTION OF THE DRAWINGS

In order to illustrate the technical schemes of the embodiments of the present disclosure or prior art more clearly, the following will briefly introduce the attached drawings used in the description of the embodiments or the prior art. Obviously, the attached drawings in the following description are some embodiments of the present disclosure, and for those skilled in the art, other drawings can also be obtained from these drawings without any creative effort.

FIG. 1 is a schematic diagram of an application environment of a lane line recognition method in one embodiment;

FIG. 2 is a flow diagram of a lane line recognition method in one embodiment;

FIG. 2A is a structural diagram of a lane lines recognition model in one embodiment;

FIG. 3 is a flow diagram of a lane line recognition method in another embodiment;

FIG. 4 is a flow diagram of a lane line recognition method in still another embodiment;

FIG. 4A is a schematic diagram of a merging area in one embodiment;

FIG. 5 is a flow diagram of a lane line recognition method in another embodiment;

FIG. 5A is a schematic diagram of a connection area in one embodiment;

FIG. 6 is a flow diagram of a lane line recognition method in another embodiment;

FIG. 7 is a flow diagram of a lane line recognition method in another embodiment;

FIG. 8 is a flow diagram of a lane line recognition method in another embodiment;

FIG. 8A is a schematic diagram of intersections of lane lines in one embodiment;

FIG. 9 is a flow diagram of a lane line recognition method in another embodiment;

FIG. 10 is a structural diagram of a lane line recognition apparatus provided in one embodiment;

FIG. 11 is a structural diagram of a lane line recognition apparatus provided in another embodiment;

FIG. 12 is a structural diagram of a lane line recognition apparatus provided in another embodiment;

FIG. 13 is a structural diagram of a lane line recognition apparatus provided in another embodiment;

FIG. 14 is a structural diagram of a lane line recognition apparatus provided in another embodiment;

FIG. 15 is a structural diagram of a lane line recognition apparatus provided in another embodiment;

FIG. 16 is a structural diagram of a lane line recognition apparatus provided in another embodiment;

FIG. 17 is an internal structure diagram of a computer device in one embodiment;

FIG. 18 schematically shows a block diagram of a computing processing device used to perform the method according to the present disclosure; and

FIG. 19 schematically shows a storage unit for holding or carrying program codes for implementing the method according to the present disclosure.

### DETAILED DESCRIPTION

The lane line recognition method, the apparatus, the device, and the storage medium provided by the present application aim to solve the problem of inaccurate lane lines determined by traditional methods. The technical schemes of the present application and how the technical schemes of the present application solve the above technical problems will be described in detail through the embodiments and in combination with the accompanying drawings. The following specific embodiments can be combined with each other, and the same or similar concepts or processes may not be repeated in some embodiments. It should be understood that the specific embodiments described herein are only used to explain the present application and are not used to limit the present application. Obviously, the described embodiments are part of the embodiments of the present disclosure, not all of them. Based on the embodiments of the present disclosure, all other embodiments obtained by ordinary technicians in the art without creative work belong to the protection scope of the present disclosure.

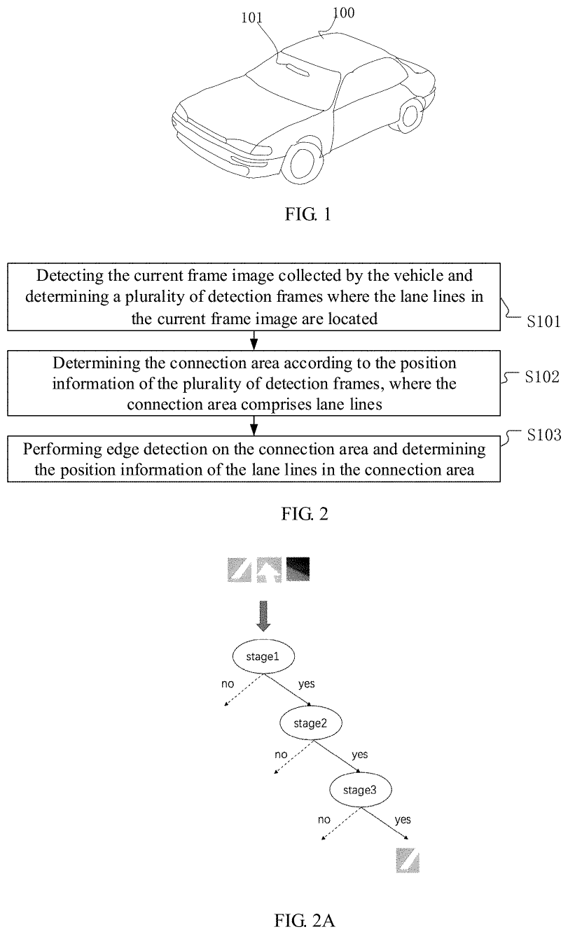

The lane line recognition method provided by this embodiment can be applied to the application environment shown in FIG. 1. The lane line recognition apparatus 101 arranged on the vehicle 100 is used to perform the method steps shown in FIG. 2-FIG. 9 below. It should be noted that, the lane line recognition method provided by this embodiment can also be applied to the application environment of robot pathfinding in the logistics warehouse, in which the robot performs path recognition by identifying the lane lines, which is not limited by the embodiments of the present disclosure.

It should be noted that the execution subject of the lane line recognition method provided by the embodiments of the present disclosure can be a lane line recognition apparatus, which can be realized as part or all of a lane line recognition terminal by means of software, hardware or a combination of software and hardware.

In order to make the purpose, technical schemes and advantages of the embodiments of the present disclosure clearer, the technical schemes in the embodiments of the present disclosure will be clearly and completely described below in combination with the attached drawings in the embodiments of the present disclosure. Obviously, the described embodiments are part of the embodiments of the present disclosure, not all of the embodiments.

FIG. 2 is a flow diagram of a lane line recognition method in one embodiment. This embodiment relates to a specific process of obtaining the position information of the lane lines by detecting the current frame image. As shown in FIG. 2, the method comprises following steps.

S101: detecting the current frame image collected by the vehicle and determining a plurality of detection frames where the lane lines in the current frame image are located.

The current frame image can be the image collected by the image acquisition device arranged on the vehicle, and the current frame image can comprise the environment information around the vehicle when the vehicle is driving. Generally, the image acquisition device is a camera, and the data it collects is video data, that is, the current frame image can be the image corresponding to the current frame in the video data. The detection frame can be an area comprising lane lines in the current frame image and is a roughly selected area of lane lines in the current frame image. The position information of the detection frame can be used to indicate the position of the lane line area in the current frame image. It should be noted that the detection frame can be an area smaller than the area of the position of all lane lines, that is to say, one detection frame usually comprises only part of the lane lines, not all the lane lines.

When detecting the current frame image collected by the vehicle and determine the plurality of detection frames where the lane lines in the current frame image are located, it can be realized by image detection technology. For example, a plurality of detection frames where the lane lines in the current frame image are located can be determined through the lane line area recognition model.

S102: determining the connection area according to the position information of the plurality of detection frames, where the connection area comprises lane lines.

Generally, one frame of image may comprises a plurality of lane lines, so the detection frames indicating the same lane line can be connected to obtain one connection area, which comprises one lane line. That is, when acquiring a plurality of detection frames, the detection frames indicating that the lane lines coincide can be connected according to the position information of the detection frames so as to obtain the connection area.

S103: performing edge detection on the connection area and determining the position information of the lane lines in the connection area.

The position information of the lane lines can be used to indicate the area where the lane lines in the environment image are located, which can mark lane lines in the environment image by different colors. When the connection area is obtained, edge detection can be performed on the position in the current frame image indicated by the connection area, that is to say, the edge area with significantly different image pixel grayscale in the connection area can be selected to determine the position information of the lane lines.

In the above lane line recognition method, the position information of the lane lines is determined by first detecting the current frame image collected by the vehicle, determining a plurality of detection frames where the lane lines in the current frame image are located, determining the connection area which comprises the lane lines according to the position information of the plurality of detection frames, and then performing edge detection on the connection area and determining the position information of the lanes lines in the connection area. That is to say, the position information of the lane lines is obtained by first dividing the current frame image into a plurality of detection frames, then connecting the detection frames to obtain the connection area comprising the lane lines, and then performing edge detection on the connection area, so as to avoid the problem of inaccurate position information of the determined lane lines when the pixel grayscale of the environment image changes drastically, thereby improving the accuracy of the position information of the determined lane lines.

Optionally, the current frame image is input into the lane line classification model to obtain a plurality of detection frames where the lane lines in the current frame image are located; and the lane line classification model comprises at least two classifiers that are cascaded.

The lane line classification model can be a traditional neural network model. For example, the lane line classification model can be an Adaboost model, and its structure can be shown as FIG. 2A. The lane line classification model can comprise at least two classifiers that are cascaded, and whether lane lines are comprised in the image is determined through each level of the classifiers.

When the current frame image is input into the lane line classification model to obtain a plurality of detection frames where the lane lines in the current frame image are located, the current frame image of the vehicle can be directly input into the lane line classification model, and a plurality of detection frames corresponding to the current frame image can be output through the mapping relationship between the current frame image and the detection frame preset in the lane line classification model; it is also possible to perform a scaling operation on the current frame image of the vehicle according to the preset scaling ratio, so that the size of the scaled current frame image matches the size of the area that can be recognized by the lane line classification model. After the scaled current frame image is input into the lane line classification model, a plurality of detection frames corresponding to the current frame image is output through the mapping relationship between the current frame image and the detection frame preset in the lane line classification model. The embodiments of the present disclosure do not limit this aspect.

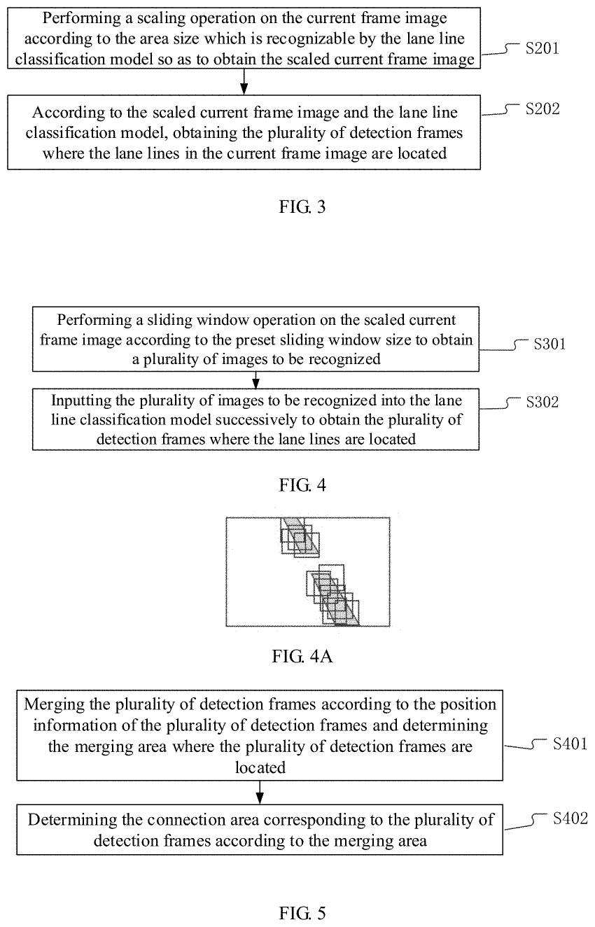

FIG. 3 is a flow diagram of a lane line recognition method in another embodiment. This embodiment relates to the specific process of how to detect the current frame image collected by the vehicle and determine a plurality of detection frames where the lane lines in the current frame image are located. As shown in FIG. 3, a possible implementation of S101 “detecting the current frame image collected by the vehicle and determining a plurality of detection frames where the lane lines in the current frame image are located” comprises following steps.

S201: performing a scaling operation on the current frame image according to the area size which is recognizable by the lane line classification model so as to obtain the scaled current frame image.

When the lane line classification model is a traditional neural network model, the area size identified by the traditional neural network model is a fixed size, for example, the fixed size is 20×20, or the fixed size is 30×30. When the size of the lane line area in the current frame image collected by the image acquisition device is greater than the above fixed size, the lane line classification model cannot recognize and obtain the position information of a plurality of lane line areas according to the current frame image in the case where the current frame image is directly input into the lane line classification model. The current frame image can be scaled through scaling operation to obtain the scaled current frame image, so that the size of the lane line area in the scaled current frame image can match the size of the area which can be recognized by the lane line classification model.

S202: obtaining a plurality of detection frames where the lane lines in the current frame image are located according to the scaled current frame image and the lane line classification model.

Optionally, the specific process of obtaining the position information of the plurality of lane line areas according to the scaled current frame image and the lane line classification model can be shown in FIG. 4. As shown in FIG. 4, a possible implementation of above S202 “obtaining a plurality of detection frames where the lane lines in the current frame image are located according to the scaled current frame image and the lane line classification model” comprises following steps.

S301: performing a sliding window operation on the scaled current frame image according to the preset sliding window size so as to obtain a plurality of images to be recognized.

The preset sliding window size can be obtained according to the area size that can be recognized by the above lane line classification model. The preset sliding window size can be the same as the area size that can be recognized by the lane line classification model, or it can be slightly smaller than the area size that can be recognized by the lane line classification model, and the embodiments of the present disclosure do not limit this. According to the preset sliding window size, the sliding window operation can be performed on the scaled current frame image to obtain a plurality of images to be recognized, and the size of the image to be recognized is obtained according to the preset sliding window size. For example, the size of the scaled current frame image is 800×600, and the preset sliding window size is 20×20, so that the image in the window determined with the coordinate (0,0) as the starting point and the coordinate (20,20) as the ending point can be regarded as the first image to be recognized according to the preset sliding window size, and then the image in the window determined with the coordinate (2,0) as the starting point and the coordinate (22,20) as the ending point is obtained by sliding 2 along the x-axis coordinate according to the preset sliding window step 2, and is regarded as the second image to be recognized. The window is slid successively until the image in the window determined with the coordinate (780,580) as the starting point and the coordinate (800,600) as the ending point is taken as the last image to be recognized, so as to obtain a plurality of images to be recognized.

S302: inputting the plurality of images to be recognized into the lane line classification model successively to obtain the plurality of detection frames where the lane lines are located.

When the plurality of images to be recognized are input into the lane line classification model successively, the lane line classification model can judge whether the image to be recognized is an image of the lane lines through the classifier. The classifier can be at least two classifiers that are cascaded. When the last-level classifier determines that the image to be recognized is an image of lane lines, the position information corresponding to the image to be recognized determined as the image of lane lines can be determined as a plurality of detection frames where the lane lines are located, that is, the plurality of detection frames where the lane lines are located can be small windows shown in FIG. 4A.

In the above lane line recognition method, the terminal performs a scaling operation on the current frame image according to the area size which is recognizable by the lane line classification model so as to obtain the scaled current frame image, and obtains the position information of a plurality of lane line areas according to the scaled current frame image and the lane line classification model, so that when the lane line classification model is a traditional neural network model, the current frame image that does not match the area size which can be recognized by the traditional neural network model cannot be recognized. At the same time, due to the simple structure of the traditional neural network model, the traditional neural network model is used as the lane line classification model to obtain the position information of the lane line area of the current frame image, and the amount of calculation is small. Therefore, there is no need to use a chip with high computing capability to acquire the position information of the lane line area of the current frame image, and thus, the cost of the apparatus required for lane line recognition is reduced.

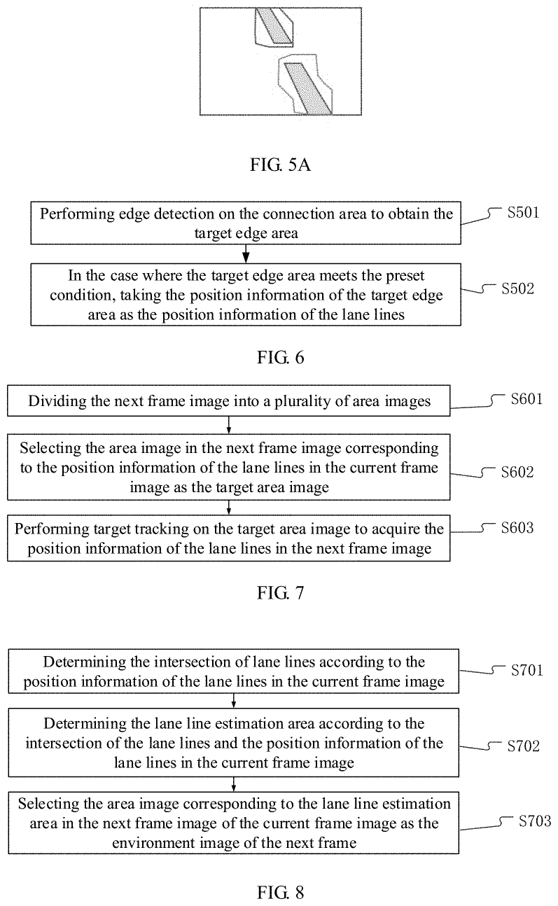

FIG. 5 is a flow diagram of a lane line recognition method in another embodiment. This embodiment relates to the specific process of how to determine the connection area according to the position information of a plurality of detection frames. As shown in FIG. 5, a possible implementation of S102 “determining the connection area according to the position information of a plurality of detection frames” comprises following steps.

S401: merging the plurality of detection frames according to the position information of the plurality of detection frames and determining the merging area where the plurality of detection frames are located.

According to the position information of the detection frames, a plurality of detection frames with overlapping positions are determined, and the detection frames with overlapping positions are merged to obtain the merging area where the plurality of detection frames are located. Based on the description in the above embodiments, each detection frame comprises part of lane lines, and a plurality of detection frames with overlapping positions usually correspond to one complete lane line. Therefore, a plurality of detection frames with overlapping positions are merged to obtain the merging area where a plurality of detection frames are located, and the merging area usually comprises one complete lane line. For example, the merging area may be two merging areas shown in FIG. 4A.

S402: determining the connection area corresponding to the plurality of detection frames according to the merging area.

On the basis of the above S401, after the merging area are obtained, the frame detection can be carried out on the merging area to obtain the connection area corresponding to the plurality of detection frames. It should be noted that the connection area can be the largest circumscribed polygon corresponding to the merging area, the largest circumscribed circle corresponding to the merging area, or the largest circumscribed sector corresponding to the merging area, and the embodiments of the present disclosure do not limit this. For example, the connection area may be the largest circumscribed polygon of two merging areas shown in FIG. 5A.

Optionally, edge detection may be performed on the connection area through the embodiment shown in FIG. 6 to determine the position information of the lane lines in the connection area. As shown in FIG. 6, a possible implementation of above 103 “performing edge detection on the connection area and determining the position information of the lane lines in the connection area” comprises following steps.

S501: performing edge detection on the connection area to obtain the target edge area.

S502: taking the position information of the target edge area as the position information of the lane lines in the case where the target edge area meets the preset condition.

When the edge detection is performed on the connection area and the target edge area obtained is inaccurate, that is, there is a case that the target edge area is not a lane line, and thus whether the target edge area comprises a lane line can be determined by judging whether the target edge area meets the preset condition. When the target edge area meets the preset condition, the position information of the target edge area is used as the position information of the lane lines.

Optionally, the preset condition comprises at least one selected from group consisting of: the target edge area comprises a left edge and a right edge, the distal width of the target edge area is less than the proximal width of the target edge area, and the distal width of the target edge area is greater than the product of the proximal width and the width coefficient.

Because a lane line is usually a line of a preset width on a plane image, it can be determined that the target edge area may be a lane line when the target edge area comprises both the left edge and the right edge. When the target edge area comprises only the left edge or only the right edge, the target edge area cannot be a lane line, which is a misjudgment. At the same time, in the plane image, the lane lines meet the principle of “near thick and far thin”. Therefore, when the distal width of the target edge area is less than the proximal width, the target edge area may be a lane line. Further, the change degree of the width of the lane lines can be defined by the condition of the distal width of the target edge area being greater than the product of the proximal width and the width coefficient. For example, in the case of determining whether the distal width of the target edge area is less than the proximal width, it can be determined by the following formula:

length(i)≥length(i+1) and 0.7*length(i)πlength(i+1)

That is, when the target edge area comprises a left edge and a right edge, or the distal width of the target edge area is less than the proximal width, the target edge area is the recognition result of the lane lines.

In the above lane line recognition method, the terminal performs edge detection on the connection area to obtain the target edge area. In the case where the target edge area meets the preset condition, the position information of the target edge area is taken as the position information of the lane lines, and the preset condition is used to determine whether the target edge area comprises a lane line. That is to say, after edge detection is performed on the connection area and the target edge area is obtained, further, by judging whether the target edge area meets the preset condition, and taking the position information of the target edge area meeting the preset condition as the position information of the lane lines, the situation that the position information of the determined lane lines is inaccurate due to misjudgment when the position information of the target edge area obtained by edge extraction of the target area is directly used as the position information of the lane lines is avoided, and further the accuracy of the position information of the determined lane lines is improved.

On the basis of the above embodiments, when recognizing the lane lines of the next frame image of the current frame image, the target tracking may be performed on the next frame image according to the position information of the lane lines in the current frame image, so as to obtain the position information of the lane lines in the next frame image. Optionally, according to the position information of the lane lines in the current frame image, target tracking is performed on the next frame image of the current frame image so as to acquire the position information of the lane lines in the next frame image.

When the position information of the lane lines in the current frame image is determined, the color and brightness of the lane lines in the position information of the lane lines can be compared with the next frame image of the current frame image, and the area in the next frame image that matches the color and brightness of the lane lines in the current frame image can be tracked to obtain the position information of the lane lines in the next frame image.

Optionally, target tracking may be performed on the next frame image of the current frame image through the embodiment shown in FIG. 7 to acquire the position information of the lane lines in the next frame image, which comprises following steps.

S601: dividing the next frame image into a plurality of area images.

When target tracking is performed on the next frame image according to the position information of the lane lines, and when the illumination in the next frame image changes, such as the reflection caused by the puddles on the road, there is a ponding area in the next frame image, and the brightness of the ponding area is significantly different from other areas. When target tracking is directly performed on the next frame image, it is easy to misjudge due to the high brightness of the ponding area. At this time, the next frame image can be divided into a plurality of area images, so that the brightness of the lane lines in each area image is uniform, so as to avoid misjudgment caused by too high brightness of ponding area.

S602: selecting the area image in the next frame image corresponding to the position information of the lane lines in the current frame image as the target area image.

S603: performing target tracking on the target area image to acquire the position information of the lane lines in the next frame image.

In the lane line recognition method, the next frame image is divided into a plurality of area images, the area image in the next frame image corresponding to the position information of the lane lines in the current frame image is selected as the target area image, target tracking is performed on the target area image, and the position information of the lane lines in the next frame image is acquired, which avoids the existence of abnormal brightness area caused by illumination change in the next frame image, further avoids the wrong target area image obtained by misjudging the abnormal brightness area, and improves the accuracy of the position information of the lane lines in the next frame image obtained by performing target tracking on the target area image.

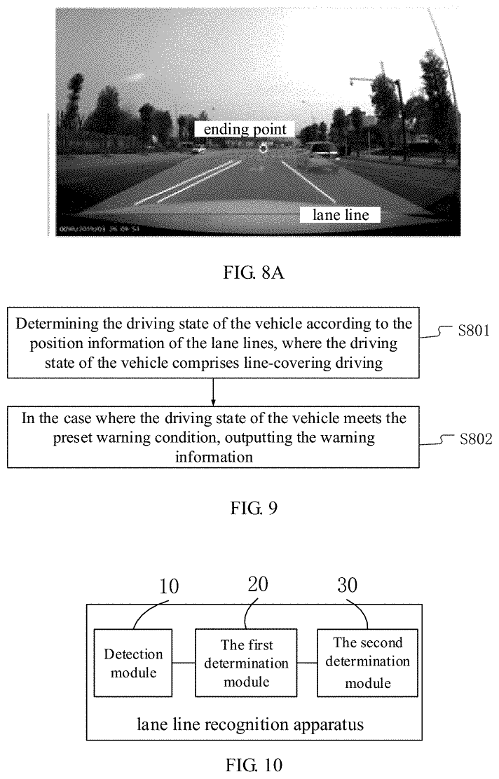

When the position information of the lane lines in the current frame image is determined and the position information of the lane lines needs to be determined for the next frame image of the current frame image, the lane line estimation area can be determined according to the position information of the lane lines in the current frame image, and the area image corresponding to the lane line estimation area in the next frame image can be used as the next frame image. As shown in FIG. 8, the method also comprises following steps described in detail below with reference to FIG. 8.

S701: determining the intersection of lane lines according to the position information of the lane lines in the current frame image.

Generally, lane lines appear in pairs, that is, the lane lines in the environment image are usually two lane lines. As shown in FIG. 8A, there is an intersection on the extension lines of the two lane lines, that is, the intersection of the lane lines. This intersection is usually located on the horizon of the image.

S702: determining the lane line estimation area according to the intersection of the lane lines and the position information of the lane lines in the current frame image.

When the intersection of lane lines is obtained, the current frame image can be divided into two areas according to the intersection of lane lines. The area comprising lane lines is regarded as the lane line estimation area. When the current frame image is divided into two areas which include the upper area of the image and the lower area of the image, generally speaking, because the intersection is usually located on the horizon of the image, that is, the upper area of the image is the sky and the lower area of the image is the ground, i.e., the area where the lane lines are located, the lower area of the image is determined as the lane line estimation area.

S703: selecting the area image corresponding to the lane line estimation area in the next frame image of the current frame image as the environment image of the next frame.

In the above lane line recognition method, the intersection of the lane lines is determined according to the position information of the lane lines in the current frame image, the lane line estimation area is determined according to the intersection of the lane lines and the position information of the lane lines in the current frame image, and the area image corresponding to the lane line estimation area in the next frame image of the current frame image is selected as the environment image of the next frame. That is to say, the next frame image only comprises the lane line estimation area, so that the amount of data required to be calculated when determining the position information of the lane lines in the next frame image is small, which improves the efficiency of determining the position information of the lane lines in the next frame image.

When the recognition result of lane lines is determined, it can also be determined whether to output warning information according to the recognition result and the current position information of the vehicle. The following is described in detail with reference to FIG. 9.

FIG. 9 is a flow diagram of a lane line recognition method in another embodiment. This embodiment relates to a specific process of determining whether to output warning information according to the position information of the lane lines and the current position information of the vehicle. As shown in FIG. 9, the method also comprises following steps.

S801: determining the driving state of the vehicle according to the position information of the lane lines, where the driving state of the vehicle comprises line-covering driving.

On the basis of the above embodiments, after the position information of the lane lines is determined, the driving state of the vehicle can be calculated according to the position information of the image acquisition device installed on the vehicle, that is to say, whether the vehicle drives on the line. For example, when the image acquisition device is installed on the vehicle, whether the vehicle drives on the line can be determined according to the position where the image acquisition device is installed on the vehicle, the lane line recognition result and the vehicle's own parameters, such as the height and width of the vehicle.

S802: in the case where the driving state of the vehicle meets the warning condition that is preset, outputting the warning information.

When the driving state of the vehicle is line-covering driving and meets the preset warning condition, the warning information is output. Optionally, the warning condition comprises that the vehicle drives on a solid line, or the duration of the vehicle on a dotted line exceeds a preset duration threshold, that is to say, when the driving state of the vehicle is line-covering driving, and the vehicle is driving on a solid line, or the vehicle is in the line-covering driving state, and the duration of the vehicle on the dotted line exceeds the preset duration threshold, the driving state of the vehicle meets the preset warning condition, and thus the warning information is output. The warning information may be a voice prompt, a beeper or a flashing light, which is not limited in the embodiments of the present disclosure.

In the above lane line recognition method, the terminal determines the driving state of the vehicle according to the position information of the lane lines and the current position information of the vehicle. The driving state of the vehicle comprises line-covering driving. In the case where the driving state of the vehicle meets the preset warning condition, the terminal outputs warning information. The warning condition comprises that the vehicle is driving on the solid line, or the duration of the vehicle on the dotted line exceeds the preset duration threshold, so that when the vehicle is driving on the solid line, or the duration on the dotted line exceeds the preset duration threshold, the warning information may be output and the driver can be prompted to ensure driving safety.

It should be understood that although the steps in the flowchart of FIG. 2 to FIG. 9 are shown in sequence according to the arrows, these steps are not necessarily performed in sequence according to the arrows. Unless explicitly stated in this document, there is no strict sequence restriction on the execution of these steps, and these steps can be executed in other sequences. Moreover, at least part of the steps in FIG. 2 to FIG. 9 may comprise a plurality of sub-steps or a plurality of stages. These sub-steps or stages are not necessarily executed and completed at the same time, but may be executed at different times. The execution sequence of these sub-steps or stages is not necessarily sequential, but may be executed in turn or alternately with other steps or at least part of sub-steps or stages of other steps.

FIG. 10 is a structural diagram of a lane line recognition apparatus provided in an embodiment. As shown in FIG. 10, the lane line recognition apparatus comprises a detection module 10, a first determination module 20 and a second determination module 30.

The detection module 10 is used for the detection module, which is configured to detect the current frame image collected by the vehicle and determine a plurality of detection frames where the lane lines in the current frame image are located.

The first determination module 20 is configured to determine a connection area according to the position information of the plurality of detection frames, and the connection area comprises lane lines.

The second determination module 30 is configured to perform edge detection on the connection area and determine the position information of the lane lines in the connection area.

In an embodiment, the detection module 10 is specifically used to input the current frame image into the lane line classification model to obtain a plurality of detection frames where the lane lines in the current frame image are located. The lane line classification model comprises at least two classifiers that are cascaded.

The lane line recognition apparatus provided by the embodiments of the present disclosure can execute the above method of the above embodiments, and its implementation principle and the technical effect are similar to those of the method, which will not be repeated here.

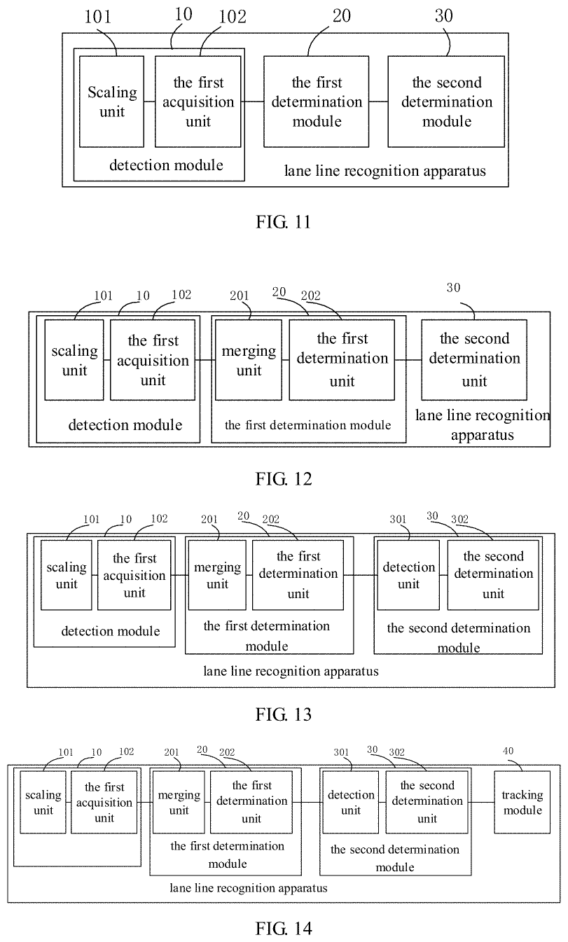

FIG. 11 is a structural diagram of the lane line recognition apparatus provided in another embodiment. On the basis of the embodiment shown in FIG. 10, as shown in FIG. 11, the detection module 10 comprises a scaling unit 101 and a first acquisition unit 102.

The scaling unit 101 is configured to perform a scaling operation on the current frame image according to the area size which is recognizable by the lane line classification model so as to obtain the scaled current frame image.

The first acquisition unit 102 is configured to obtain a plurality of detection frames where the lane lines in the current frame image are located according to the scaled current frame image and the lane line classification model.

In an embodiment, the first acquisition unit 102 is specifically used to perform a sliding window operation on the scaled current frame image according to the preset sliding window size to obtain a plurality of images to be recognized, and is used to input the plurality of images to be recognized successively into the lane line classification model so as to obtain a plurality of detection frames where the lane lines are located.

The lane line recognition apparatus provided by the embodiment of the present application can execute the above method of the above embodiment, and its implementation principle and the technical effect are similar to those of the method, which will not be repeated here.

FIG. 12 is a structural diagram of the lane line recognition apparatus provided in another embodiment. On the basis of the embodiment shown in FIG. 10 or FIG. 11, as shown in FIG. 12, the first determination module 20 comprises a merging unit 201 and a first determination unit 202.

The merging unit 201 is configured to merge a plurality of detection frames according to the position information of the plurality of detection frames and determine the merging area where the plurality of detection frames are located.

The first determination unit 202 is used to determine the connection area corresponding to the plurality of detection frames according to the merging area.

It should be noted that FIG. 12 is shown based on FIG. 11. Of course, FIG. 12 can also be shown based on FIG. 10. Here is only an example.

The lane line recognition apparatus provided by the embodiment of the present application can execute the above method of the above embodiments, and its implementation principle and the technical effect are similar to those of the method, which will not be repeated here.

FIG. 13 is a structural diagram of the lane line recognition apparatus provided in another embodiment. On the basis of the embodiment shown in any one of FIG. 10 to FIG. 12, as shown in FIG. 13, the second determination module 30 comprises a detection unit 301 and a second determination unit 302

The detection unit 301 is configured to perform edge detection on the connection area to obtain a target edge area.

The second determination unit 302 is configured to take the position information of the target edge area as the position information of the lane lines in the case where the target edge area meets the preset condition.

In an embodiment, the above preset condition comprises at least one selected from a group consisting of: the target edge area comprises a left edge and a right edge, the distal width of the target edge area is less than the proximal width, and the distal width of the target edge area is greater than the product of the proximal width and the width coefficient.

It should be noted that FIG. 13 is shown based on FIG. 12. Of course, FIG. 13 can also be shown based on FIG. 10 or FIG. 11. Here is only an example.

The lane line recognition apparatus provided by the embodiment of the present application can execute the above method of the above embodiments, and its implementation principle and the technical effect are similar to those of the method, which will not be repeated here.

FIG. 14 is a structural diagram of the lane line recognition apparatus provided in another embodiment. On the basis of the embodiment shown in any one of FIG. 10 to FIG. 13, as shown in FIG. 14, the lane line recognition apparatus also comprises a tracking module 40

The tracking module 40 is configured to perform target tracking on the next frame image of the current frame image according to the position information of the lane lines in the current frame image, and acquire the position information of the lane lines in the next frame image.

In an embodiment, the tracking module 40 is specifically used to divide the next frame image into a plurality of area images, select the area image in the next frame image corresponding to the recognition result of lane lines in the current frame image as the target area image, and perform target tracking on the target area image to acquire the position information of the lane lines in the next frame image.

It should be noted that FIG. 14 is shown based on FIG. 13. Of course, FIG. 14 can also be shown based on any one of FIG. 10 to FIG. 12. Here is only an example.

The lane line recognition apparatus provided by the embodiment of the present application can execute the above method of the above embodiments, and its implementation principle and the technical effect are similar to those of the method, which will not be repeated here.

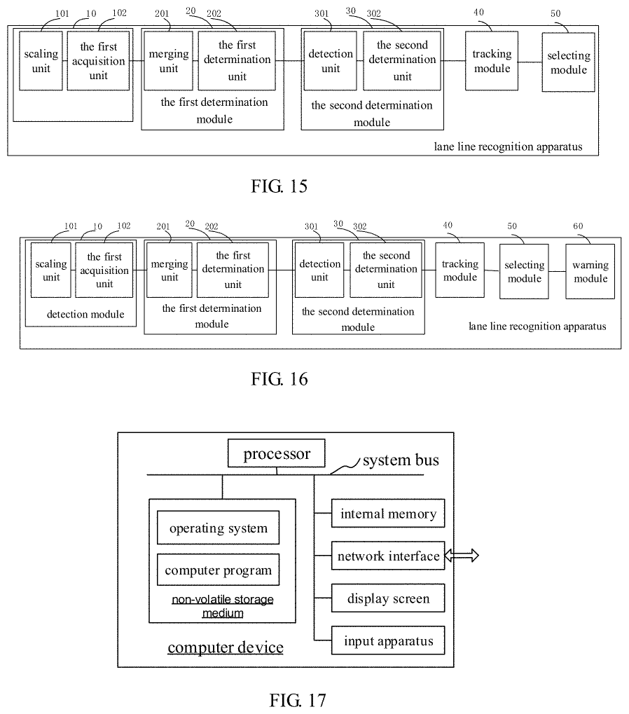

FIG. 15 is a structural diagram of the lane line recognition apparatus provided in another embodiment. On the basis of the embodiment shown in any one of FIG. 10 to FIG. 14, as shown in FIG. 15, the lane line recognition apparatus also comprises a selection module 50

The selection module 50 is specifically used to determine the intersection of lane lines according to the position information of the lane lines in the current frame image, determine the lane line estimation area according to the intersection of lane lines and the position information of the lane lines in the current frame image, and select the area image corresponding to the lane line estimation area in the next frame image of the current frame image as the next frame image.

It should be noted that FIG. 15 is shown based on FIG. 14. Of course, FIG. 15 can also be shown based on any one of FIG. 10 to FIG. 13. Here is only an example.

The lane line recognition apparatus provided by the embodiment of the present application can execute the above method of the above embodiments, and its implementation principle and the technical effect are similar to those of the method, which will not be repeated here.

FIG. 16 is a structural diagram of the lane line recognition apparatus provided in another embodiment. On the basis of the embodiment shown in any one of FIG. 10 to FIG. 15, as shown in FIG. 16, the lane line recognition apparatus also comprises a warning module 60

The warning module 60 is specifically used to determine the driving state of the vehicle according to the position information of the lane lines. The driving state of the vehicle comprises line-covering driving. The warning module 60 is also used to output the warning information in the case where the driving state of the vehicle meets the preset warning condition.

In an embodiment, the above warning condition comprises that the vehicle is driving on the solid line, or the duration of the vehicle covering the dotted line exceeds the preset duration threshold.

It should be noted that FIG. 16 is shown based on FIG. 15. Of course, FIG. 16 can also be shown based on any one of FIG. 10 to FIG. 14. Here is only an example.

The lane line recognition apparatus provided by the embodiment of the present application can execute the above method of the above embodiments, and its implementation principle and the technical effect are similar to those of the method, which will not be repeated here.

For the specific definition of a lane line recognition apparatus, reference may be made to the definition of the lane line recognition method above, which will not be repeated here. Each module in the lane line recognition apparatus can be realized in whole or in part by software, hardware and their combinations. The above modules can be embedded in or independent of the processor in the computer device in the form of hardware, or stored in the memory in the computer device in the form of software, so that the processor can call and execute the corresponding operations of the above modules.

In an embodiment, a computer device is provided, which can be a terminal device, and its internal structure diagram can be shown in FIG. 17. The computer device comprises a processor, a memory, a network interface, a display screen and an input device connected through a system bus. The processor of the computer device is used to provide computing and control capabilities. The memory of the computer device comprises a non-volatile storage medium and an internal memory. The non-volatile storage medium stores an operating system and computer programs. The internal memory provides an environment for the operation of the operating system and the computer program in the non-volatile storage medium. The network interface of the computer device is used to communicate with an external terminal through a network connection. The computer program is executed by the processor to realize a lane line recognition method. The display screen of the computer device can be a liquid crystal display screen or an electronic ink display screen. The input apparatus of the computer device can be a touch layer covered on the display screen, a key, a trackball or a touchpad set on the shell of the computer device, or an external keyboard, touchpad or mouse, etc.

Those skilled in the art can understand that the structure shown in FIG. 17 is only a block diagram of some structures related to the scheme of the present disclosure, and does not constitute a limitation on the computer device to which the scheme of the present disclosure is applied. The specific computer device may comprise more or fewer components than those shown in the figure, or combine certain components, or have different arrangements of components.

In an embodiment, a terminal device is provided, which comprises a memory and a processor, the memory stores a computer program, and the processor implements the following steps when executing the computer program:

detecting the current frame image collected by the vehicle and determining a plurality of detection frames where the lane lines in the current frame image are located;

determining a connection area according to the position information of the plurality of detection frames, where the connection area comprises lane lines; and

performing edge detection on the connection area and determining the position information of the lane lines in the connection area.

In an embodiment, when the processor executes the computer program, it also realizes the following steps: inputting the current frame image into the lane line classification model to obtain a plurality of detection frames where the lane lines in the current frame image are located. The lane line classification model comprises at least two classifiers that are cascaded.

In an embodiment, when executing the computer program, the processor also implements the following steps: performing a scaling operation on the current frame image according to the area size which is recognizable by the lane line classification model so as to obtain the scaled current frame image; and obtaining the plurality of detection frames of lane lines in the current frame image according to the scaled current frame image and the lane line classification model.

In an embodiment, when the processor executes the computer program, it also implements the following steps: performing a sliding window operation on the scaled current frame image according to the preset sliding window size so as to obtain a plurality of images to be recognized; and successively inputting the plurality of images to be recognized into the lane line classification model to obtain the plurality of detection frames where the lane lines are located.

In an embodiment, when the processor executes the computer program, it also implements the following steps: merging the plurality of detection frames according to the position information of the plurality of detection frames and determining the merging area where the plurality of detection frames are located; and according to the merging area, determining the connection area corresponding to the plurality of detection frames.

In an embodiment, when the processor executes the computer program, it also implements the following steps: performing edge detection on the connection area to obtain the target edge area; and in the case where the target edge area meets the preset condition, taking the position information of the target edge area as the position information of the lane lines.

In an embodiment, the above preset condition comprises at least one selected from a group consisting of the following: the target edge area comprises a left edge and a right edge, the distal width of the target edge area is less than the proximal width of the target edge area, and the distal width of the target edge area is greater than the product of the proximal width and the width coefficient.

In an embodiment, when the processor executes the computer program, it also implements the following steps: according to the position information of the lane lines in the current frame image, performing target tracking on the next frame image of the current frame image and acquiring the position information of the lane lines in the next frame image.

In an embodiment, when the processor executes the computer program, it also implements the following steps: dividing the next frame image into a plurality of area images; selecting the area image in the next frame image corresponding to the position information of the lane lines in the current frame image as the target area image; and performing target tracking on the target area image to acquire the position information of the lane lines in the next frame image.

In an embodiment, when the processor executes the computer program, it also implements the following steps: determining the intersection of lane lines according to the position information of lane lines in the current frame image; determining the lane line estimation area according to the intersection of lane lines and the position information of lane lines in the current frame image; and selecting the area image corresponding to the lane line estimation area in the next frame image of the current frame image as the next frame image.

In an embodiment, when the processor executes the computer program, it also implements the following steps: determining the driving state of the vehicle according to the position information of the lane lines, where the driving state of the vehicle comprises line-covering driving; and in the case where the driving state of the vehicle meets the preset warning condition, outputting the warning information.

In an embodiment, the above warning condition comprises that the vehicle is driving on the solid line, or the duration of the vehicle on the dotted line exceeds the preset duration threshold.

The implementation principle and technical effect of the terminal device provided in this embodiment are similar to those of the above method embodiment, and will not be repeated here.

In an embodiment, a computer-readable storage medium is provided on which a computer program is stored. The computer program implements the following steps when executed by a processor:

detecting the current frame image collected by the vehicle, and determining a plurality of detection frames where the lane lines in the current frame image are located;

determining a connection area according to the position information of the plurality of detection frames, where the connection area comprises lane lines; and

performing edge detection on the connection area and determining the position information of the lane lines in the connection area.

In an embodiment, when the computer program is executed by the processor, the following steps are realized: inputting the current frame image into the lane line classification model to obtain a plurality of detection frames where the lane lines in the current frame image are located. The lane line classification model comprises at least two classifiers that are cascaded.

In an embodiment, when the computer program is executed by the processor, the following steps are realized: performing a scaling operation on the current frame image according to the area size which is recognizable by the lane line classification model to obtain the scaled current frame image; and according to the scaled current frame image and the lane line classification model, obtaining the plurality of detection frames of lane lines in the current frame image.

In an embodiment, when the computer program is executed by the processor, the following steps are realized: performing a sliding window operation on the scaled current frame image according to the preset sliding window size to obtain a plurality of images to be recognized; and successively inputting the plurality of images to be recognized into the lane line classification model to obtain the plurality of detection frames where the lane lines are located.

In an embodiment, when the computer program is executed by the processor, the following steps are realized: merging the plurality of detection frames according to the position information of the plurality of detection frames and determining the merging area where the plurality of detection frames are located; and according to the merging area, determining the connection area corresponding to the plurality of detection frames.

In an embodiment, when the computer program is executed by the processor, the following steps are realized: performing edge detection on the connection area to obtain the target edge area; and in the case where the target edge area meets the preset condition, taking the position information of the target edge area as the position information of the lane lines.

In an embodiment, the above preset condition comprises at least one selected from a group consisting of the following: the target edge area comprises a left edge and a right edge, the distal width of the target edge area is less than the proximal width of the target edge area, and the distal width of the target edge area is greater than the product of the proximal width and the width coefficient.

In an embodiment, when the computer program is executed by the processor, the following steps are realized: according to the position information of the lane lines in the current frame image, performing target tracking on the next frame image of the current frame image to acquire the position information of the lane lines in the next frame image.

In an embodiment, when the computer program is executed by the processor, the following steps are realized: dividing the next frame image into a plurality of area images; selecting the area image in the next frame image corresponding to the position information of the lane lines in the current frame image as the target area image; and performing the target tracking on the target area image to acquire the position information of the lane lines in the next frame image.

In an embodiment, when the computer program is executed by the processor, the following steps are realized: determining the intersection of lane lines according to the position information of the lane lines in the current frame image; determining the lane line estimation area according to the intersection of lane lines and the position information of lane lines in the current frame image; and selecting the area image corresponding to the lane line estimation area in the next frame image of the current frame image as the next frame image.

In an embodiment, when the computer program is executed by the processor, the following steps are realized: determining the driving state of the vehicle according to the position information of the lane lines, where the driving state of the vehicle comprises line-covering driving; and in the case where the driving state of the vehicle meets the preset warning condition, outputting the warning information.

In an embodiment, the above warning condition comprises that the vehicle is driving on the solid line, or the duration of the vehicle covering the dotted line exceeds the preset duration threshold.

The implementation principle and technical effect of the computer-readable storage medium provided by this embodiment are similar to those of the above embodiment of the method, and will not be repeated here.

Those of ordinary skill in the art can understand that all or part of the process of implementing the above embodiment method can be completed by instructing relevant hardware through a computer program. The computer program can be stored in a non-volatile computer-readable storage medium. When the computer program is executed, the process of the above embodiments can be realized. Any reference to memory, storage, database or other media used in the various embodiments provided by the present disclosure may comprise non-volatile and/or volatile memory. The non-volatile memory may comprise read only memory (ROM), programmable ROM (PROM), electrically programmable ROM (EPROM), electrically erasable programmable ROM (EEPROM), or flash memory. The volatile memory may comprise random access memory (RAM) or external cache memory. By way for illustration but not for limitation, RAM is available in various forms, such as static RAM (SRAM), dynamic RAM (DRAM), synchronous DRAM (SDRAM), dual data rate SDRAM (DDRSDRAM), enhanced SDRAM (ESDRAM), synchronous link (synchlink) DRAM (SLDRAM), rambus direct RAM (RDRAM), direct memory bus dynamic RAM (DRDRAM), memory bus dynamic RAM (RDRAM) and so on.

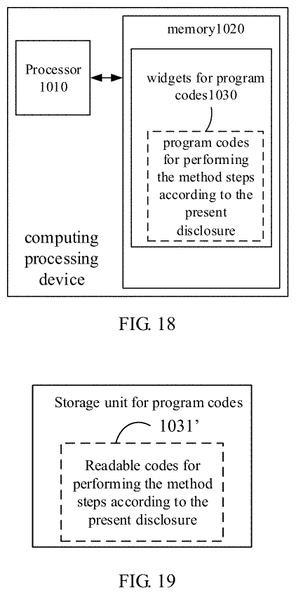

Various component embodiments of the present disclosure may be implemented by hardware, or by software modules running on one or more processors, or in a combination thereof. Those skilled in the art should understand that a microprocessor or a digital signal processor (DSP) may be used in practice to implement some or all functions of some or all components in the computing processing device according to the embodiments of the present disclosure. The present disclosure may also be implemented as a device or apparatus programs (e.g., computer programs and computer program products) for performing part or all of the methods described herein. Such a program implementing the present disclosure may be stored on a computer-readable medium or may have the form of one or more signals. Such signals may be downloaded from Internet websites, or provided on carrier signals, or provided in any other form. For example, FIG. 18 shows a computing processing device that can implement the method of the present disclosure. The computing processing device may be a computer device, which traditionally comprises a processor 1010 and a computer program product or computer-readable medium in the form of memory 1020. The memory 1020 has storage space 1030 of the program codes 1031 for performing any of the method steps in the above-described methods. For example, the storage space 1030 for program codes may comprise various program codes 1031 for implementing various steps in the above method, respectively. These program codes may be read from or written into one or more computer program products. These computer program products comprise program code carriers such as hard disks, compact disks (CD), memory cards, or floppy disks. Such computer program products are generally portable or fixed storage units as described with reference to FIG. 14. The storage unit may have storage segments, storage space, and the like arranged similarly to the memory 1020 in the computing processing device in FIG. 19. The program codes may be compressed, for example, in an appropriate form. Generally, the storage unit comprises computer-readable codes 1031′, that is, codes that can be read by a processor such as 1010, which when run by a computing processing device, causes the computing processing device to perform various steps in the method described above.

The term “one embodiment”, “an embodiment” or “one or more embodiments” herein means that the specific features, structures or characteristics described in combination with the embodiments are comprised in at least one embodiment of the present disclosure. In addition, please note that the examples of the word “in an embodiment” here do not necessarily refer to the same embodiment.

In the specification provided herein, a large amount of specific details are set forth. However, it can be understood that the embodiments of the present disclosure may be practiced without these specific details. In some instances, well-known methods, structures and techniques have not been shown in detail so as not to obscure an understanding of this specification.

In the claims, any reference symbols between parentheses shall not be constructed as a limitation of the claims. The word “comprise” does not exclude the existence of elements or steps not listed in the claims. The word “a” or “an” before an element does not exclude the existence of a plurality of such components. The present disclosure can be implemented by means of hardware comprising several different elements and by means of a properly programmed computer. In the unit claims listing several apparatuses, several of these apparatuses may be embodied specifically by the same hardware item. The use of words first, second, and third, etc. do not denote any order. These words may be interpreted as names. The technical features of the above embodiments may be combined arbitrarily. In order to make the description concise, all possible combinations of the technical features in the above embodiments are not described. However, as long as there is no contradiction in the combination of these technical features, they should be considered to be within the scope recorded in this specification. The above embodiments only express several embodiments of the present application, and the descriptions thereof are specific and detailed, but should not be construed as limiting the scope of the disclosure. It should be noted that for those skilled in the art, several modifications and improvements can be made without departing from the concept of the present disclosure, which all belong to the protection scope of the present disclosure. Therefore, the protection scope of the present disclosure shall be determined by the appended claims.

1. A lane line recognition method, comprising:
detecting a current frame image collected by a vehicle and determining a plurality of detection frames where lane lines in the current frame image are located;
determining a connection area according to position information of the plurality of detection frames, wherein the connection area comprises the lane lines; and
performing edge detection on the connection area and determining position information of the lane lines in the connection area.

2. The method according to claim 1, wherein detecting the current frame image collected by the vehicle and determining the plurality of detection frames where the lane lines in the current frame image are located comprises:
inputting the current frame image into a lane line classification model to obtain the plurality of detection frames where the lane lines in the current frame image are located,
wherein the lane line classification model comprises at least two classifiers that are cascaded.

3. The method according to claim 2, wherein inputting the current frame image into the lane line classification model to obtain the plurality of detection frames where the lane lines in the current frame image are located comprises:
performing a scaling operation on the current frame image according to an area size which is recognizable by the lane line classification model so as to obtain a scaled current frame image; and
obtaining the plurality of detection frames where the lane lines in the current frame image are located according to the scaled current frame image and the lane line classification model.

4. The method according to claim 3, wherein obtaining the plurality of detection frames where the lane lines in the current frame image are located according to the scaled current frame image and the lane line classification model comprises:
performing a sliding window operation on the scaled current frame image according to a preset sliding window size so as to obtain a plurality of images to be recognized; and
inputting the plurality of images to be recognized into the lane line classification model successively to obtain the plurality of detection frames where the lane lines are located.

5. The method according to claim 1, wherein determining the connection area according to the position information of the plurality of detection frames comprises:
merging the plurality of detection frames according to the position information of the plurality of detection frames and determining a merging area where the plurality of detection frames are located; and
determining the connection area corresponding to the plurality of detection frames according to the merging area.

6. The method according to claim 1, wherein performing the edge detection on the connection area and determining the position information of the lane lines in the connection area comprises:
performing the edge detection on the connection area to obtain a target edge area; and
taking position information of the target edge area as the position information of the lane lines in a case where the target edge area meets a preset condition.

7. The method according to claim 6, wherein the preset condition comprises at least one selecting from a group consisting of: the target edge area comprises a left edge and a right edge, a distal width of the target edge area is less than a proximal width of the target edge area, and the distal width of the target edge area is greater than a product of the proximal width and a width coefficient.

8. The method according to claim 1, further comprising:
performing target tracking on a next frame image of the current frame image according to the position information of the lane lines in the current frame image and determining position information of the lane lines in the next frame image.

9. The method according to claim 8, wherein performing the target tracking on the next frame image of the current frame image according to the position information of the lane lines in the current frame image and determining the position information of the lane lines in the next frame image comprises:
dividing the next frame image into a plurality of area images;
selecting an area image in the next frame image corresponding to the position information of the lane lines in the current frame image as a target area image; and
performing the target tracking on the target area image to acquire the position information of the lane lines in the next frame image.

10. The method according to claim 8, further comprising:
determining an intersection of the lane lines according to the position information of the lane lines in the current frame image;
determining a lane line estimation area according to the intersection of the lane lines and the position information of the lane lines in the current frame image; and
selecting an area image corresponding to the lane line estimation area in the next frame image of the current frame image as the next frame image.

11. The method according to claim 1, further comprising:
determining a driving state of the vehicle according to the position information of the lane lines, wherein the driving state of the vehicle comprises line-covering driving; and
outputting warning information in a case where the driving state of the vehicle meets a warning condition that is preset.

12. The method according to claim 11, wherein the warning condition comprises that the vehicle is driving on a solid line, or a duration of the vehicle covering a dotted line exceeds a preset duration threshold.

13. (canceled)

14. A computer device, comprising a memory and a processor, wherein the memory stores computer programs, and the processor implements steps of the method according to claim 1 when executing the computer programs.

15. A computer-readable storage medium, on which computer programs are stored, wherein the computer programs implement steps of the method according to claim 1 when executed by a processor.

16. The method according to claim 2, wherein determining the connection area according to the position information of the plurality of detection frames comprises:
merging the plurality of detection frames according to the position information of the plurality of detection frames and determining a merging area where the plurality of detection frames are located; and
determining the connection area corresponding to the plurality of detection frames according to the merging area.

17. The method according to claim 3, wherein determining the connection area according to the position information of the plurality of detection frames comprises:
merging the plurality of detection frames according to the position information of the plurality of detection frames and determining a merging area where the plurality of detection frames are located; and
determining the connection area corresponding to the plurality of detection frames according to the merging area.

18. The method according to claim 4, wherein determining the connection area according to the position information of the plurality of detection frames comprises:
merging the plurality of detection frames according to the position information of the plurality of detection frames and determining a merging area where the plurality of detection frames are located; and
determining the connection area corresponding to the plurality of detection frames according to the merging area.

19. The method according to claim 2, wherein performing the edge detection on the connection area and determining the position information of the lane lines in the connection area comprises:
performing the edge detection on the connection area to obtain a target edge area; and
taking position information of the target edge area as the position information of the lane lines in a case where the target edge area meets a preset condition.

20. The method according to claim 3, wherein performing the edge detection on the connection area and determining the position information of the lane lines in the connection area comprises:
performing the edge detection on the connection area to obtain a target edge area; and
taking position information of the target edge area as the position information of the lane lines in a case where the target edge area meets a preset condition.

21. The method according to claim 4, wherein performing the edge detection on the connection area and determining the position information of the lane lines in the connection area comprises:
performing the edge detection on the connection area to obtain a target edge area; and
taking position information of the target edge area as the position information of the lane lines in a case where the target edge area meets a preset condition.
